(19) United States
(12) Patent Application Publication
(10) Pub. No.: US 2009/0024629 A1
(43) Pub. Date: Jan. 22, 2009

(54) ACCESS CONTROL DEVICE AND METHOD THEREOF

(76) Inventor: Koji Miyauchi, Tokyo (JP)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/173,454

(22) Filed: Jul. 15, 2008

(30) Foreign Application Priority Data
Jul. 17, 2007 (JP) JP2007-185455

(51) Int. Cl. G06F 17/30

(52) U.S. Cl. 707/9

(57) ABSTRACT

Access control appropriate to each processing node is achieved by evaluating information published by the processing node. An access control device (4) ranks subjects of consumption activities by their trust values, and determines whether or not the ranked subjects include any subject whose rank is improved from the last time. When there exists a subject whose rank is improved from the last time, a subject having data to which access control information is set against the subject with an improved rank is made a proposal that the protection level in the access control information against the subject with an improved rank should be decreased. The access control device (4) also judges whether or not the ranked subjects include any subject whose rank is worsened from the last time. When there exists a subject whose rank is worsened from the last time, a subject having data to which access control information is set against the subject with a worsened rank is made a proposal that the protection level in the access control information against the subject with a worsened rank should be increased.

### PRIORITY CLAIM

The present invention claims priority under 35 U.S.C. 119 to Japanese Patent Application Serial No. JP2007-185455, filed on Jul. 17, 2008, the disclosure of which is hereby incorporated by reference in its entirety.

### TECHNICAL FIELD

The present invention relates to an access control device which proposes access control in accordance with trustworthiness of a subject and a method thereof.

### BACKGROUND ART

A ranking method that utilizes a graph's link structure has been disclosed in several documents including Non-patent Documents 1 and 6, but none of them disclose an application of the ranking method to the calculation of a trust value for security protection settings.

Conventionally, information protection has been practiced in the field of operating systems.

The UNIX (registered trademark) operating system, for example, protects resources in the computer system by setting three types of access rights, “read”, “write”, and “execute”, to three types of objects which access files in the computer system, “user”, “group”, and “others”, with the use of i-node.

As a slightly advanced version of this, Role-Based Access Control (RBAC) or extended RBAC has been proposed. The RBAC or the extended RBAC enables a computer system to give a specific right to a user having a specific role, and accordingly to achieve more flexible resource protection settings compared with the case where only i-node is employed as a protection measure.

However, the above-mentioned methods can merely provide a static measure concerned with only protection settings at one time point and are not adaptable to dynamic changes that are necessary in rapidly changing situations such as online communities, thus requiring users to pay close attention to changes in security matters.

Non-patent Document 7 discloses a dynamic Access Control List (ACL) setting method. However, the method disclosed in Non-patent Document 7 defines user attributes of predictable groups, positions, and time as a context, an ACL constraint condition, and does not propose when or how to set access settings to respond to changes in situation recognized over time.

Non-patent Document 8 discloses a method where members of a sub-community are classified into several classes and a member at a higher class is given more rights. With the method disclosed in Non-patent Document 8, what right is to be given is set not automatically but manually by the founder of the sub-community or a person commissioned by the founder.

Non-patent Document 9 is an online guide which lists up articles discussing the trust and security of the Semantic Web, and the articles introduced in the guide are not about updating access control information dynamically.

Patent Document 1 discloses a method of evaluating trustworthiness of information in a community in terms of whether the information is “supported by first-hand experience,” which is judged from the user's activity history. However, what is disclosed in Patent Document 1 differs from the trust degree based on a trust relation which trust networks handle and, furthermore, is irrelevant to updating of access control information.

Patent Document 2 mainly discloses the security of devices. What is disclosed in Patent Document 2 is a method of evaluating the trustworthiness where an authentication accuracy is assigned by a user authentication method and the accuracy is designed to decay over time. This method differs from a method of calculating the trust degree based on a trust relation in a trust network.

In Patent Document 3, a trust relation between subjects of consumption activities is extracted from various information sources including questionnaires, Web pages, magazines, and electronic bulletin boards, and is expressed in a network graph with the subjects represented by nodes and the trust relation represented by an arrow.

[Patent Document 1] JP 2002-352010 A

[Patent Document 2] JP 2004-234665 A

[Patent Document 3] JP 2005-135071 A

[Non-patent Document 1] Lawrence Page; Sergey Brin; Rajeev Motwani; Terry Winograd. The PageRank Citation Ranking: Bringing Order to the Web: Stanford University, Technical Report, 1998. (http://www-db.stanford.edu/˜backrub/pageranksub.ps)

[Non-patent Document 2] Deborah Russell; G. T. Gangemi Sr. Computer Security Basics (Japanese Edition): ASCII, 1994.

[Non-patent Document 3] Hiroaki Kikuchi, ed. Special Issue: Computer Security and Privacy Protection: Transactions of Information Processing Society of Japan, 45(8): 1801-2033, 2004.

[Non-patent Document 4] Kanta Matsuura, ed. Special Issue: Research on Computer Security Characterized in the Context of Social Responsibilities: Transactions of Information Processing Society of Japan, 46(8): 1823-2142, 2005.

[Non-patent Document 5] Keiichi Iwamura, ed. Special Issue: Research on Computer Security Propping up Ubiquitous Society: Transactions of Information Processing Society of Japan, 47(8): 2343-2612, 2006.

[Non-patent Document 6] Soumen Chakrabarti; Byron E. Dom; S. Ravi Kumar; Prabhakar Raghavan; et al. Mining the Web's Link Structure: Computer, 32(8): 60-67, 1999.

[Non-patent Document 7] Youichiro Morita; Masayuki Nakae; Ryuichi Ogawa. Dynamic Access Control Method for Ad-hoc Information Sharing Technical Report of IEICE ISEC, 105(396): 7-14, 2005.

[Non-patent Document 8] Shinji Takao; Tadashi Iijima; Akito Sakurai. Developing Bulletin Board Systems that Enable to Improve Multiple Communities and Documents: The IEICE Transactions on information and systems, J89-D(12): 2521-2535, 2006.

[Non-patent Document 9] Uwe H. Suhl and his group. Semantic Web Trust and Security Resource Guide: Freie Universitaet Berlin, (http://sites.wiwiss.fu-berlin.de/suhl/bizer/SWTSGuide), 2002-2006.

[Non-patent Document 10] Takashi Inui; Manabu Okumura. A Survey of Sentiment Analysis: Journal of Natural Language Processing, 13(3): 201-241, 2006.

### SUMMARY

### Problem to be Solved by the Invention

The present invention has been made in view of the above, and an object of the present invention is therefore to provide an access control device improved to be capable of appropriate access control of each processing node through evaluation of information published by the processing node and a method thereof.

### Means for Solving the Problem

In order to attain the above-mentioned object, the present invention provides an access control device for separately controlling access of one or more second subjects to data that is kept in one or more of multiple processing nodes by each of one or more first subjects, the second subjects being subjects excluding the first subjects, the processing nodes holding data of the first subjects each controlling access of the respective second subjects to the data of the first subjects based on access control information, including: trustworthiness information collecting means for collecting trustworthiness information, which indicates trustworthiness of each of the second subjects, from one or more of the multiple processing nodes; and access control proposal information creating means for creating the access control proposal information, which is used to separately control access of the second subjects to each piece of data of the first subjects, based on access control information that each of the first subjects sets to its own data in advance, and based on the collected trustworthiness information.

Preferably, the access control proposal information creating means includes: digitalization means for digitalizing the collected trustworthiness information; and control proposal information creating means for creating the access control proposal information based on the access control information that each of the first subjects sets to its own data in advance, and based on the digitalized trustworthiness information.

### EFFECT OF THE INVENTION

The access control device and the method according to the present invention can achieve appropriate access control of each processing node through evaluation of information published by the processing node.

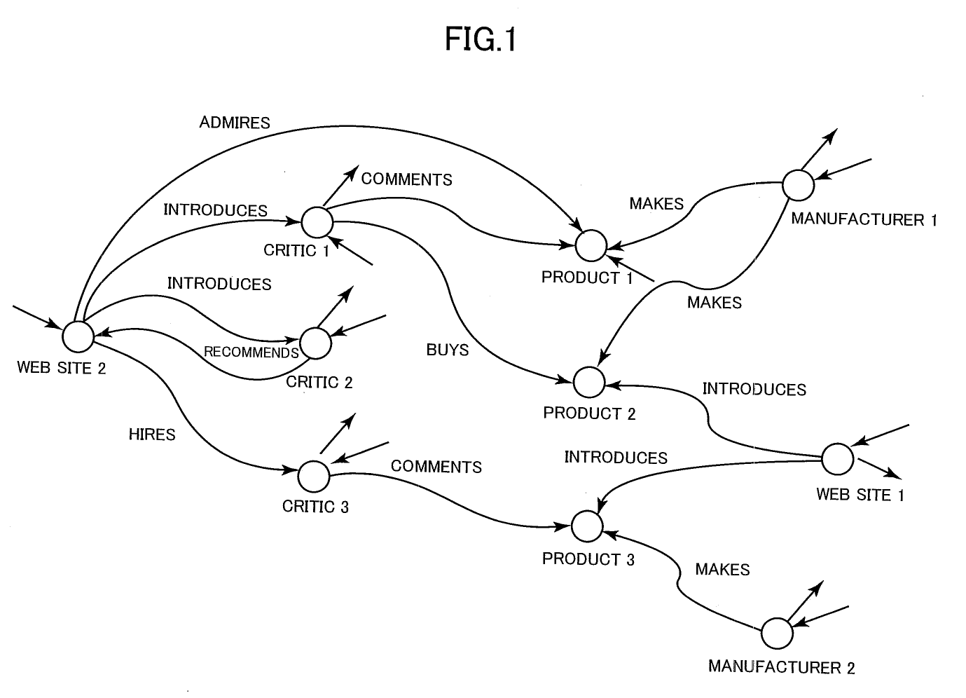

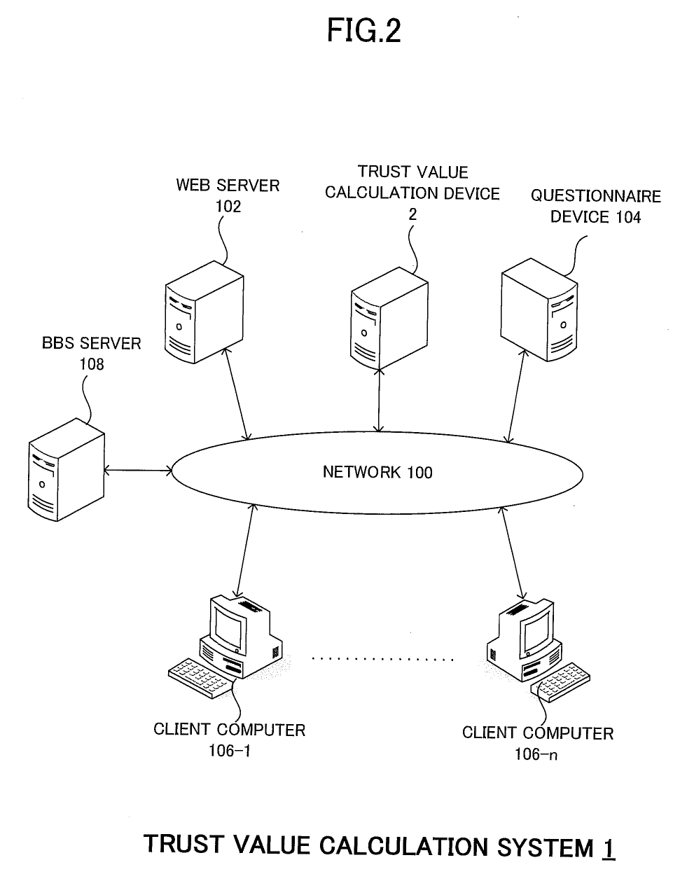

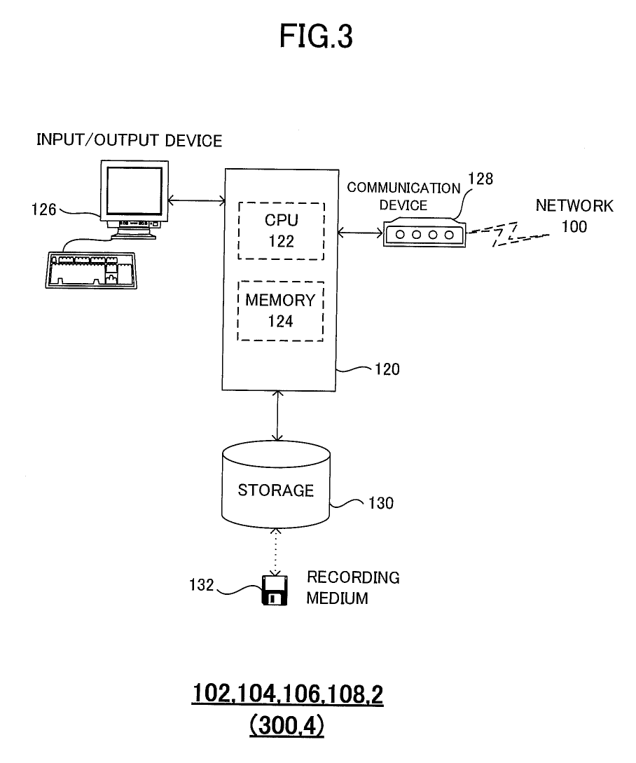

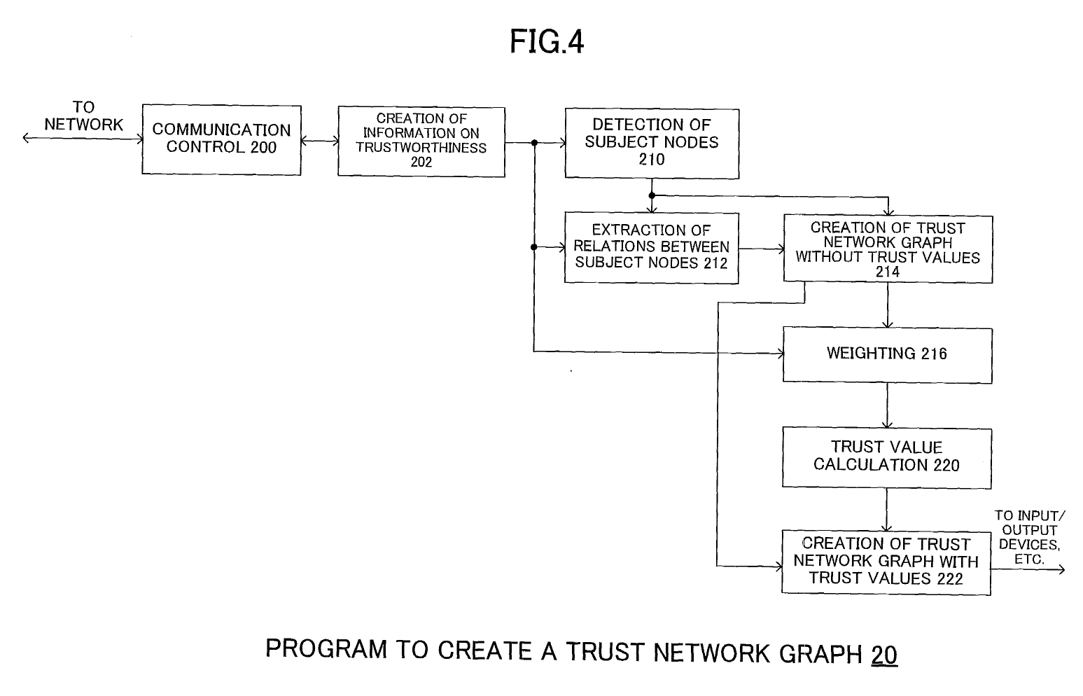

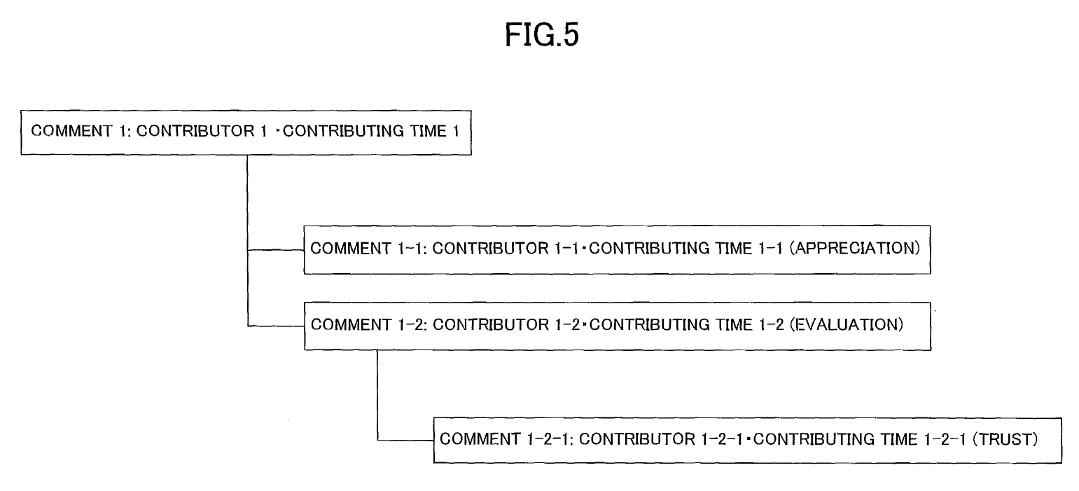

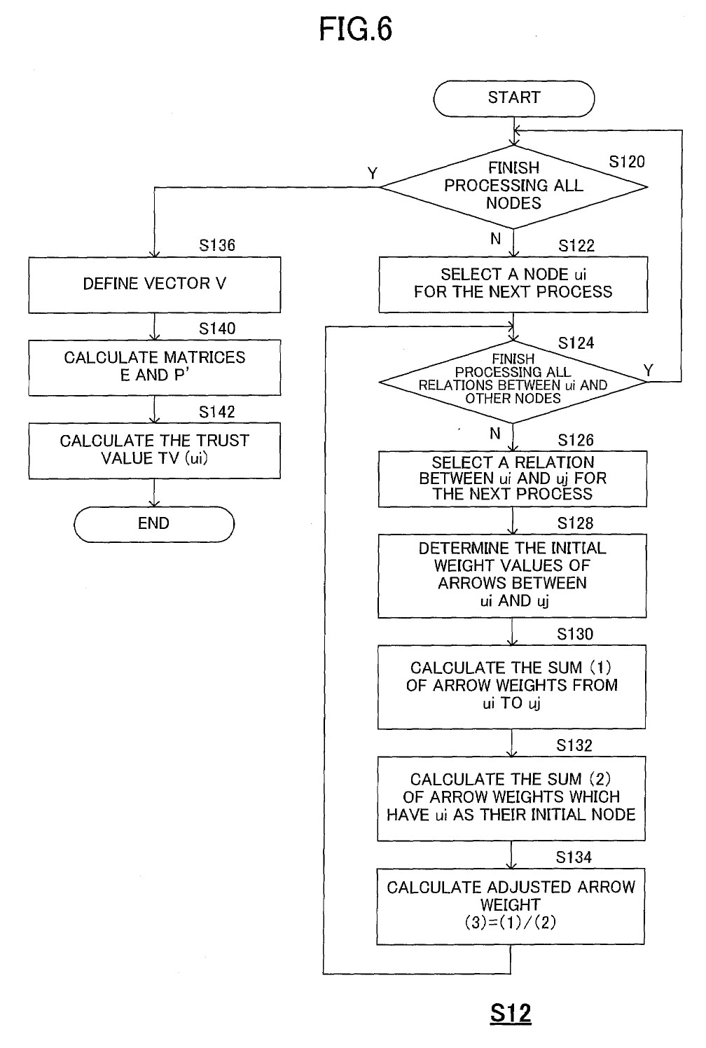

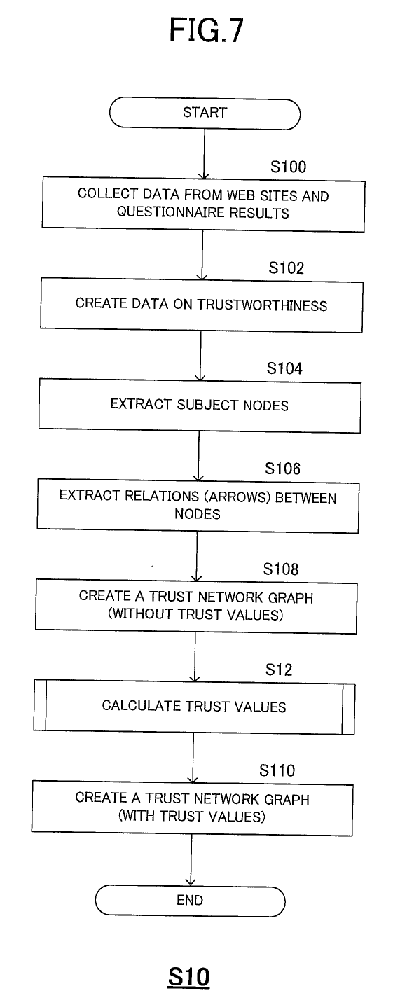

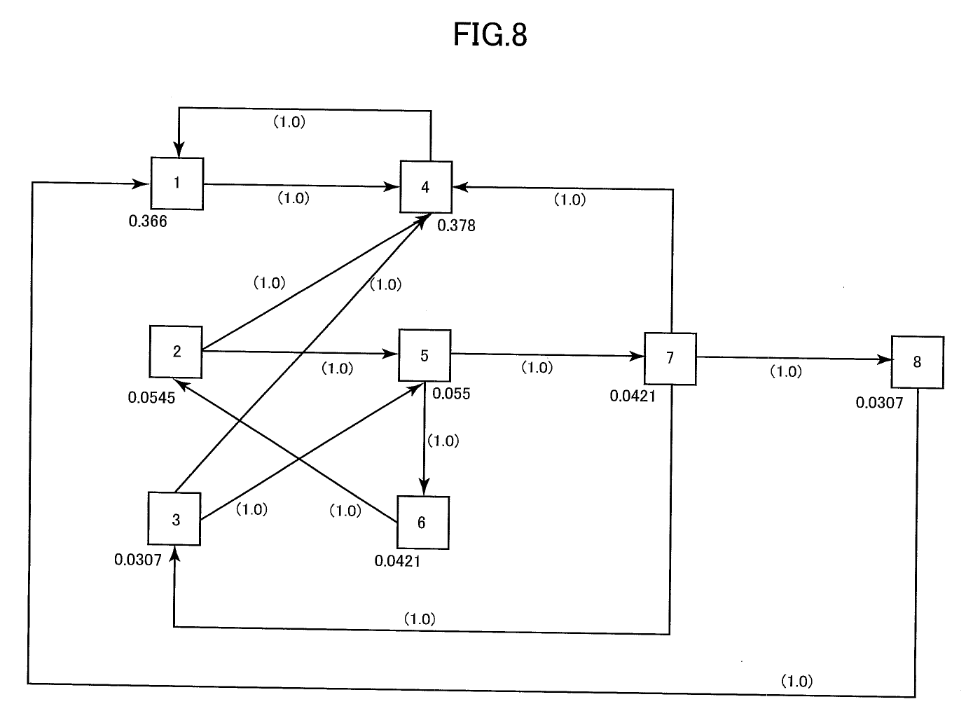

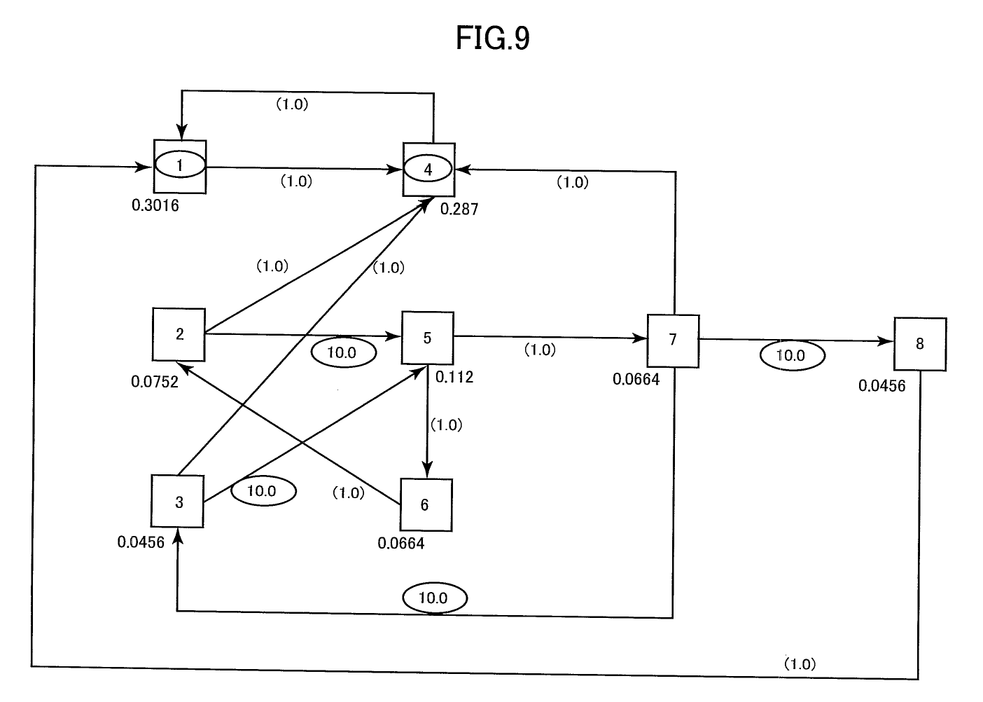

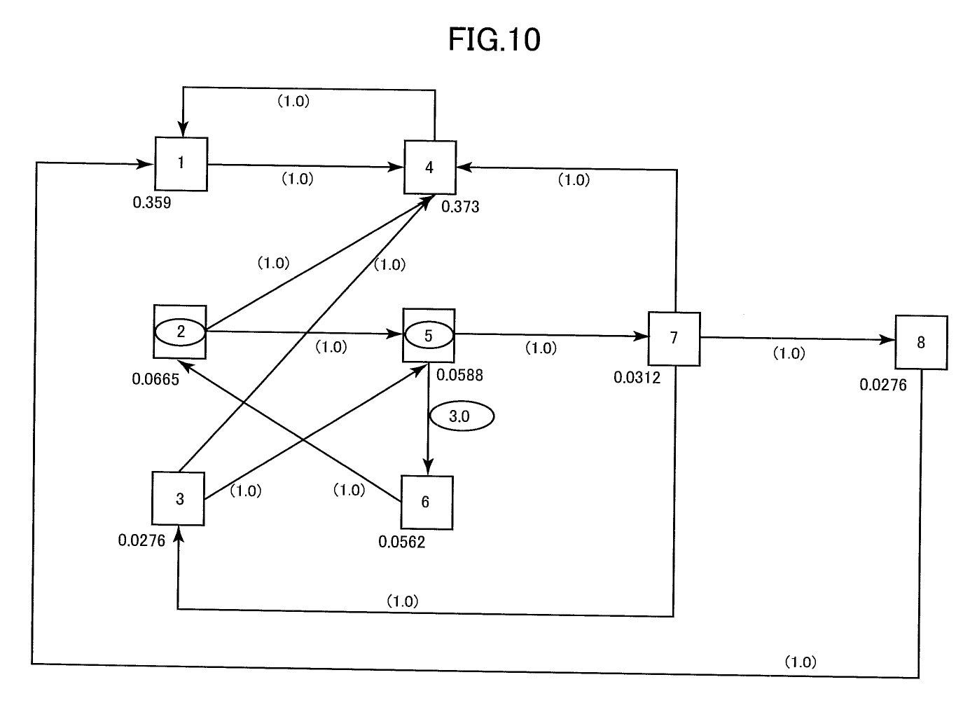

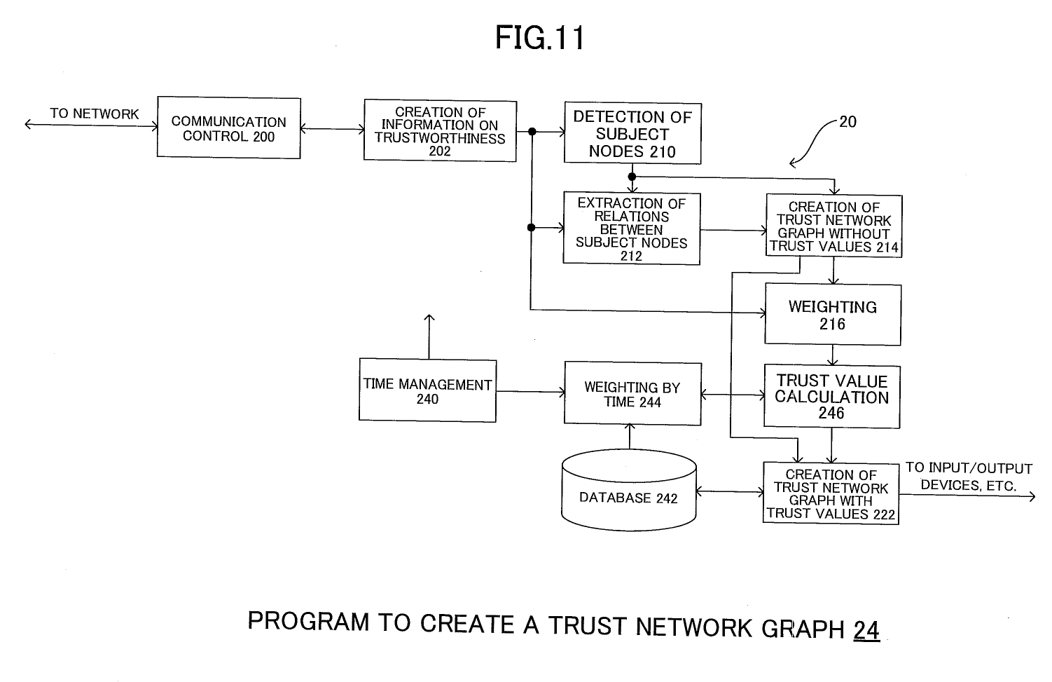

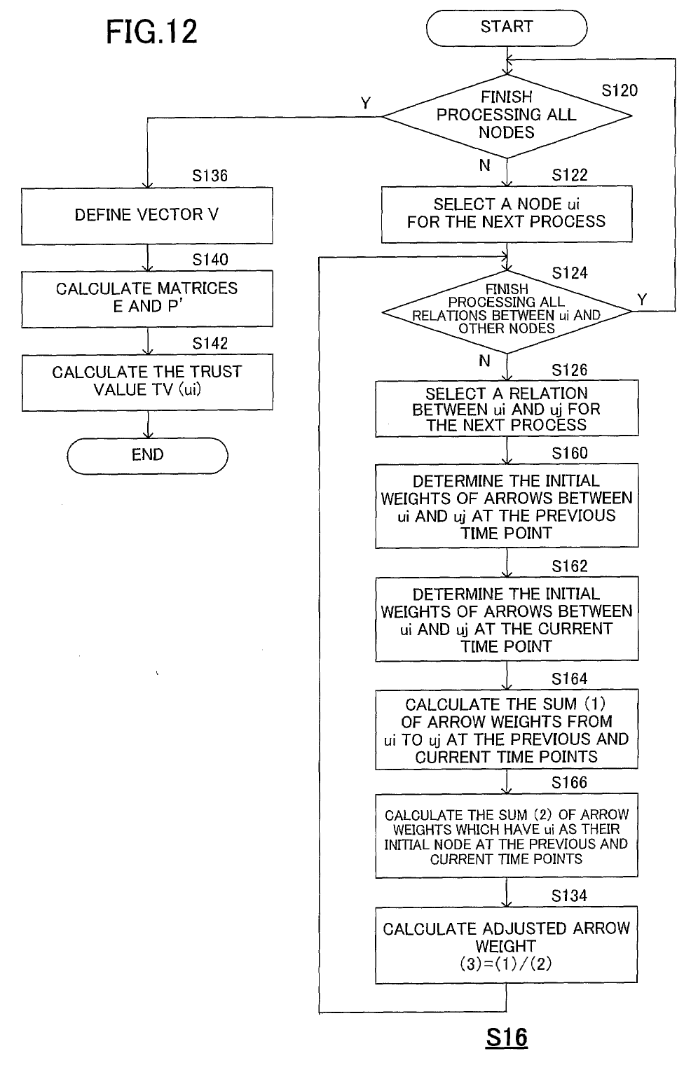

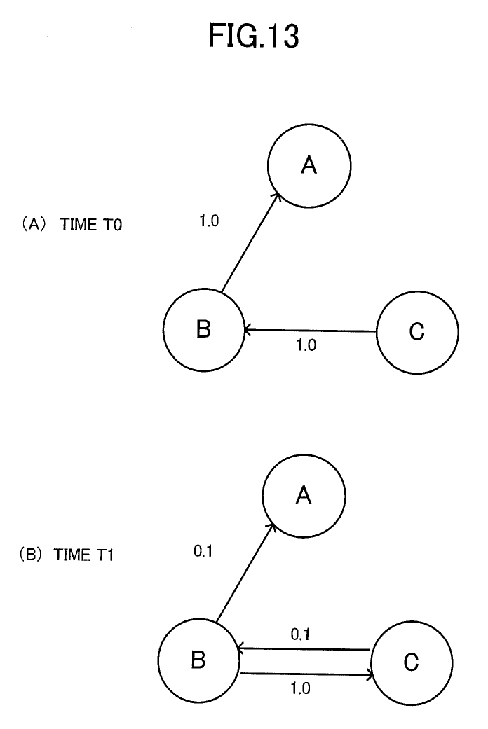

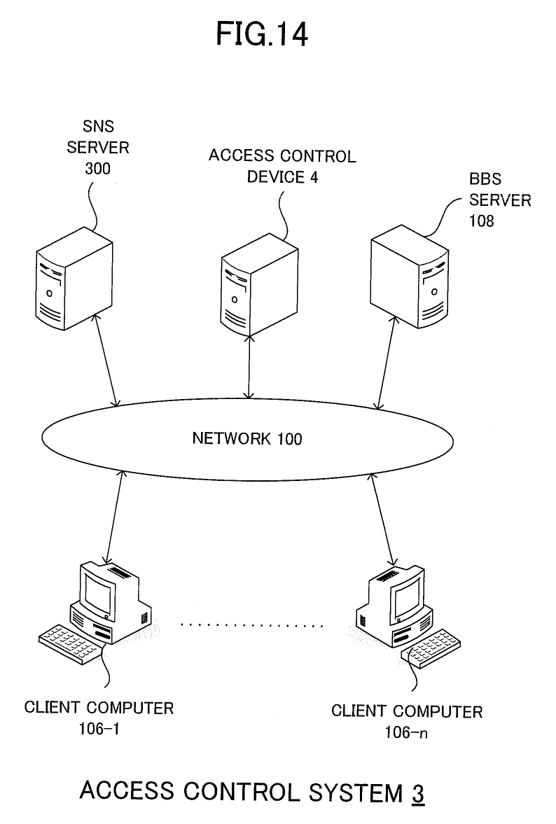

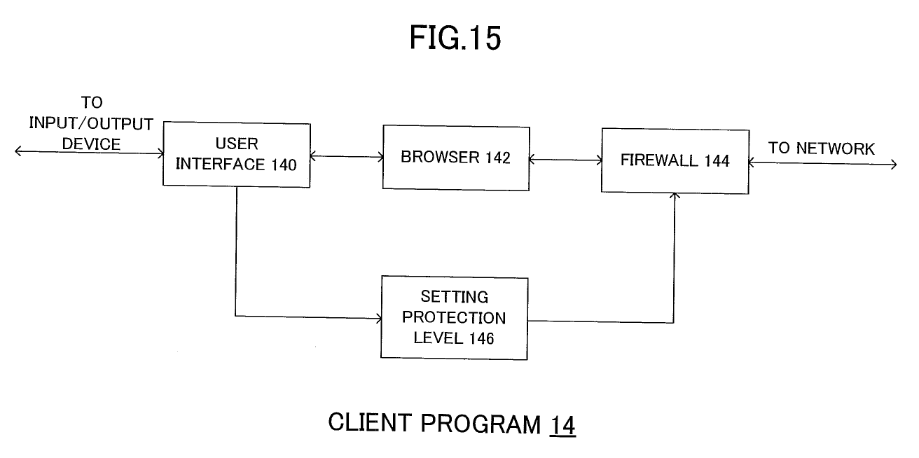

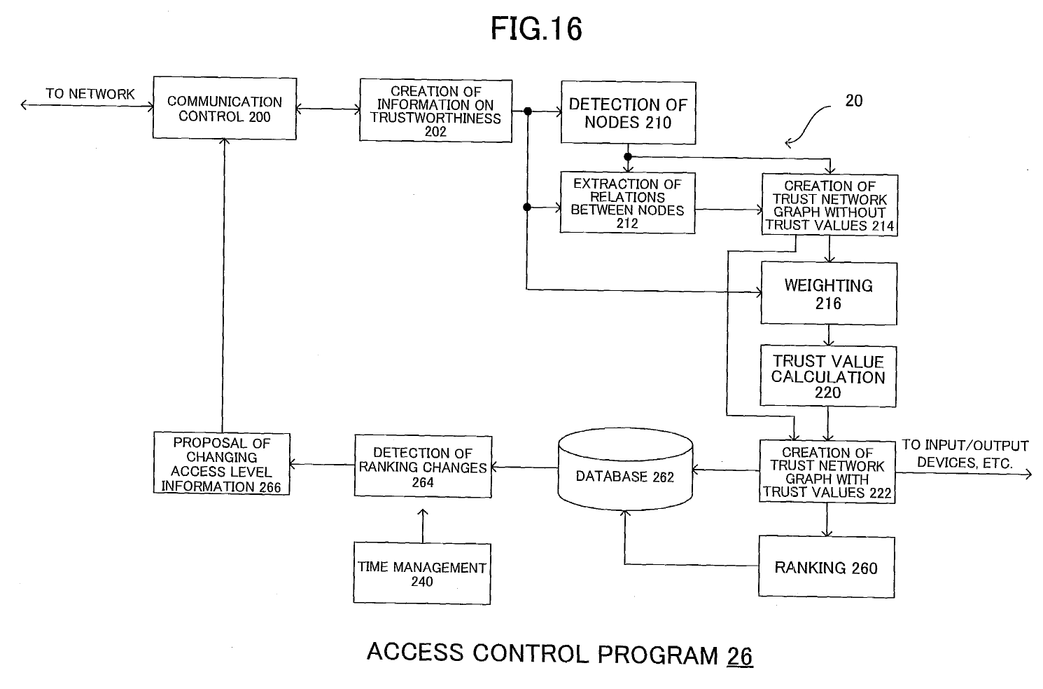

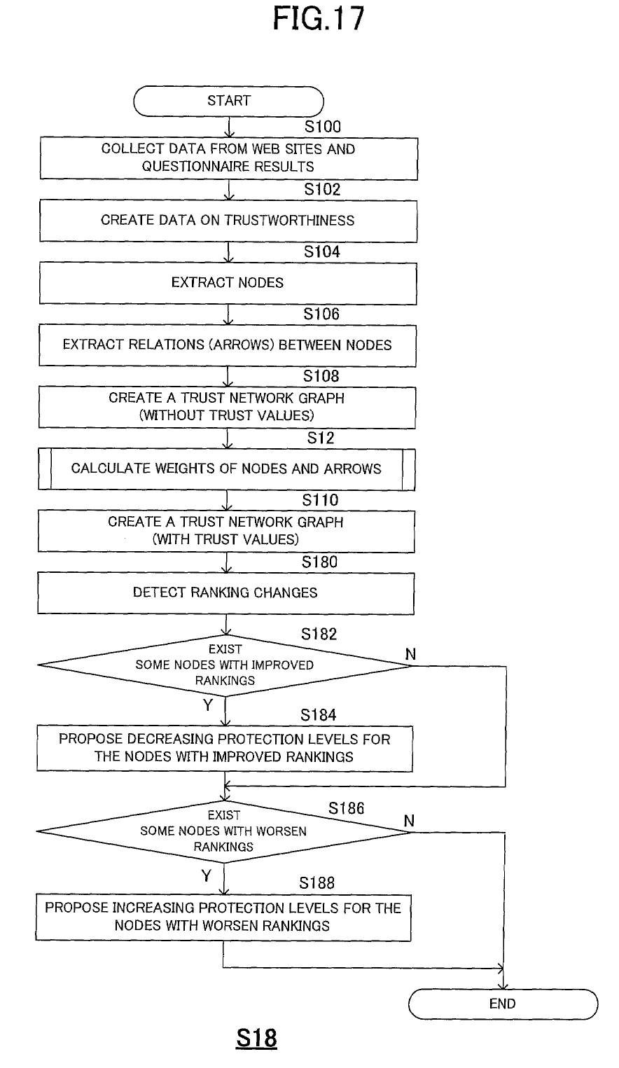

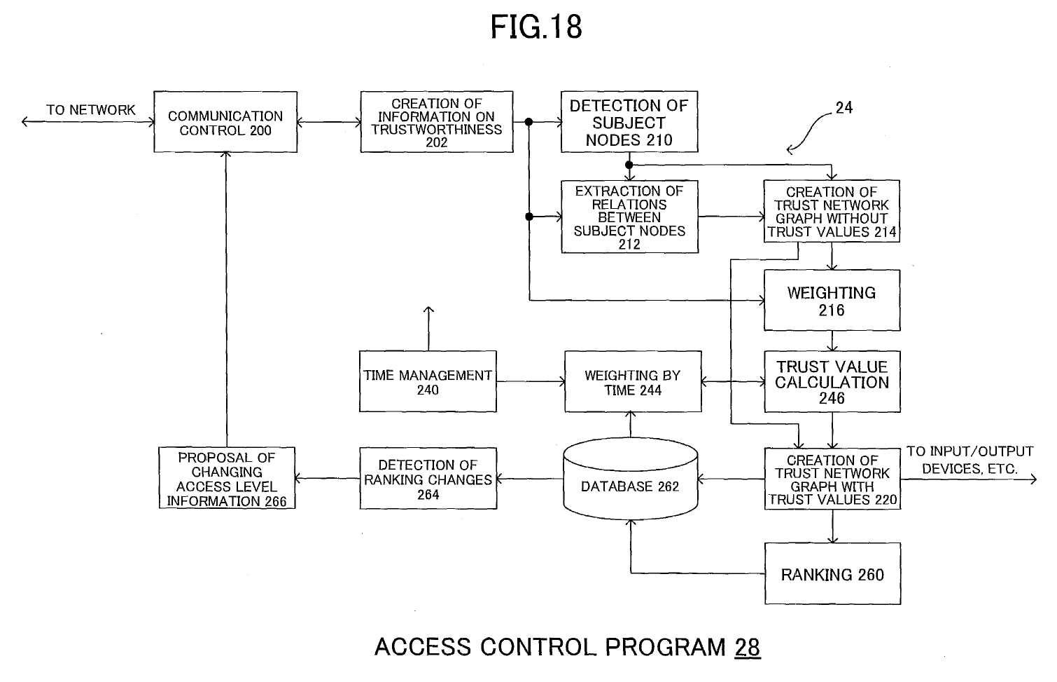

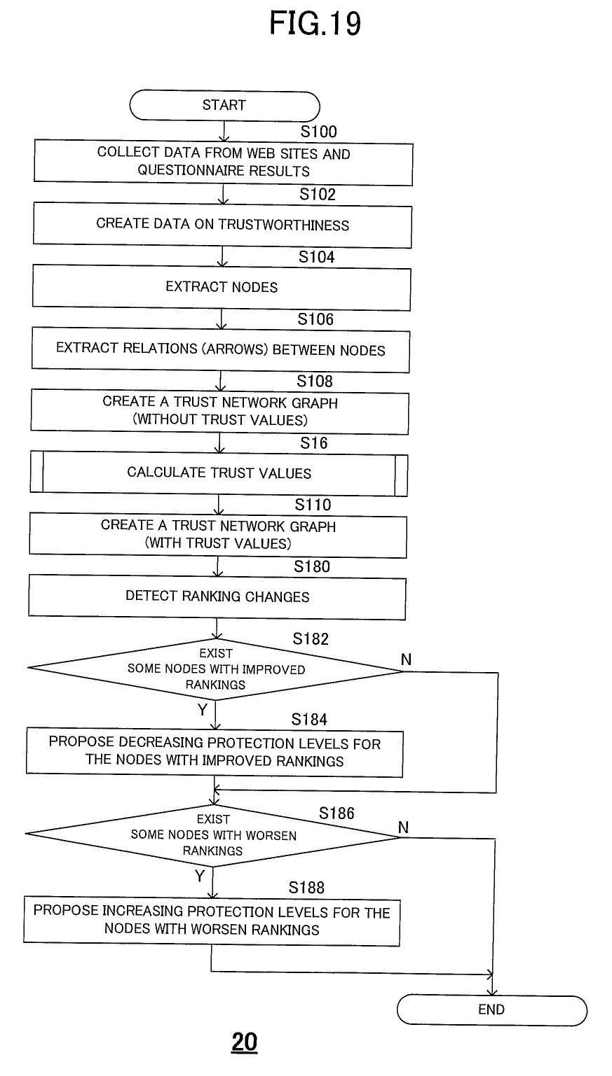

### BRIEF DESCRIPTION OF THE DRAWINGS

[FIG. 1] A diagram showing an example of a trust network graph (without trust values) which is created by a trust value calculation method according to the present invention.

[FIG. 2] A diagram showing an example of a configuration of a trust value calculation system to which the trust value calculation method according to the present invention is applied.

[FIG. 3] A diagram showing an example of a hardware configuration of a Web server, a questionnaire device, client computers, a BBS server, and a trust value calculation device shown in FIG. 2.

[FIG. 4] A diagram showing a configuration of a first trust network graph creation program, which is executed in the trust value calculation system shown in FIG. 2.

[FIG. 5] A diagram showing an example of a public post which is made by a user of the client computer on a BBS run by the BBS server shown in FIG. 1.

[FIG. 6] A flow chart showing first subject node trust value calculation processing of each subject node (S12), which is executed by a trust value calculation module shown in FIG. 4.

[FIG. 7] A flow chart showing an overall operation (S10) of the trust value calculation system of FIG. 2.

[FIG. 8] A first diagram showing an example of a trust network graph on which specific values are mapped as results of the subject node trust value calculation by the trust value calculation system.

[FIG. 9] A second diagram showing an example of a trust network graph on which specific values are mapped as results of the subject node trust value calculation by the trust value calculation system.

[FIG. 10] A third diagram showing an example of a trust network graph on which specific values are mapped as results of the subject node trust value calculation by the trust value calculation system.

[FIG. 11] A diagram showing the configuration of a second trust network graph creation program, which is run on the trust value calculation device shown in FIG. 2.

[FIG. 12] A flow chart showing second subject node trust value calculation processing of each subject node (S16), which is executed by a trust value calculation module shown in FIG. 11.

[FIG. 13] A diagram showing an example of subjects and inter-subject node relations (arrows) in a community constituted of three members (A, B, and C), with (A) showing subjects and inter-subject node relations (arrows) at a time T0 and with (B) showing subjects and inter-subject node relations (arrows) at a time T1, which is later than the time T0.

[FIG. 14] A diagram showing an example of a configuration of a first access control system according to the present invention.

[FIG. 15] A diagram showing a configuration of a client program, which is run on client computers shown in FIG. 14.

[FIG. 16] A diagram showing the configuration of the first access control program, which is run on the access control system of FIG. 14.

[FIG. 17] A flow chart showing an overall operation (S18) of the access control system of FIG. 14.

[FIG. 18] A diagram showing a configuration of a second access control program, which is used by an access control device shown in FIG. 14 in place of the first access control program of FIG. 16.

[FIG. 19] A flow chart showing an overall operation (S20) of the access control system 3 when the access control program of FIG. 18 is run in the access control device of FIG. 14.

### DETAILED DESCRIPTION

### Best Mode for Carrying Out the Invention

Background of a Trust Value Calculation Method

A further description is given on the background leading to the devising of a trust value calculation method according to the present invention.

In a community (in particular, an online community such as an electronic bulletin board (bulletin board system: BBS), a Weblog/blog, or a social networking service (SNS)), community members strongly wish to have control over how much of information about themselves is to be disclosed to whom. Such control requires trust information which indicates to what extent a community member can be trusted. In other words, the trust information helps to fulfill the community members' wish to disclose more information to trustworthy members while disclosing a limited amount of information to other members in accordance with their trust degrees.

On the other hand, online communities are created and dissolved frequently and members join and resign from online communities frequently, causing frequent changes in trust degree. The frequent changes in trust degree in turn cause significant changes in trust situation within the community or in security situation, and a member needs to adapt protection settings set to information about himself/herself according to these changes.

However, conventionally, once a user sets protection settings to information about himself/herself, the user is required to periodically review the protection settings on his/her own, and has to spend much time on what is not community activities. Moreover, having a user review his/her own protection settings also contains the risk of oversight, which makes an exhaustive reviewing of protection settings impossible.

An access control system according to the present invention described below is improved in these points.

Outline of the Trust Value Calculation Method

The trust value calculation method according to the present invention which is applied to a trust value calculation system 1 is outlined first before a description is given on the trust value calculation system 1.

Consumers, advertisement media, stores, manufacturers, experts (critics), and other various elements (hereinafter also referred to as “subjects” in everyday consumption activities) are involved in everyday consumption activities. These subjects form a diversity of relations with one another, and various types of information indicating the relations among the subjects are available to consumers.

For example, when a product A is manufactured by a manufacturer B and sold at a store C, the manufacturer B advertises the product A on the Internet and, further, the store C uses inserts in local papers to advertise the product A and the store C. Further, a critic D reviews the product A and a magazine E publishes the review. Similar consumption activities are observed for any other product and, in fact, there is an abundance of various information on consumption activities.

However, from the standpoint of consumers, such abundance of information is not necessarily welcomed because it can make it difficult to determine which manufacturer, store, expert, and the like can be trusted.

It is against this background that consumers seek for an index or information showing which manufacturer, store, expert, and the like can be trusted.

Further, the trust value information on “subjects” in consumption activities can be more beneficial to consumers if combined with a consideration to an individual's preference.

Accordingly, what consumers wish to receive is highly reliable information on subjects in consumption activities, which is matched to their preferences with the use of individuals' preference information.

FIG. 1 is a diagram showing an example of a trust network graph (without trust values) which is created through the trust value calculation method according to the present invention. The trust value calculation method according to the present invention first extracts subjects of consumption activities and trust relations between the subjects from various information sources such as questionnaires, Web pages, magazines, and electronic bulletin boards.

The trust value calculation method of the present invention next expresses the extracted trust relations between the subjects as shown in FIG. 1: in a network graph where subject nodes (different from “processing nodes” described below) represent the subjects and are connected to each other by an inter-subject node relation (an arrow pointing from one subject node to another subject node).

It should be noted that the network graph of FIG. 1, which does not contain the trust values of the subject nodes and the inter-subject node relation, is also referred to as “trust network graph without trust values” in the following description.

The trust value calculation method of the present invention next calculates the degrees of trust of the subject nodes and the inter-subject node relation (arrow), and weights the calculated values in accordance with the type of the trust relation and the extent of trust of the subjects to obtain trust values.

Then, the trust value calculation method of the present invention adds the calculated trust values to the trust network graph.

It should be noted that the trust network graph that contains trust values is also referred to as “trust network graph with trust values” in the following description.

Based on these pieces of information, the trust value calculation method of the present invention provides consumers with information that recommends and introduces products, and provides sellers with effective marketing information.

It should be noted that the trust network graph is not limited to consumption activities, and is applicable to subjects in various communities and relations between the subjects.

The trust value calculation method of the present invention determines first “subjects” whose trust values need to be calculated, and then an “inter-subject node relation (arrow)” which associates the subjects with each other. Values with which these “subjects” and “inter-subject node relation (arrow)” are weighted are also determined.

Listed below are examples of the premise that is considered in the trust value calculation method of the present invention as the basis of trust relations within consumption activities:

(1) Customers who prefer good-quality products try to purchase products of reliable manufacturers and from reliable stores.

(2) Customers seek opinions of experts and magazines they trust.

(3) Customers take notice of opinions of other customers who have actually used the product.

(4) Manufacturers and stores place an advertisement in advertisement media they trust.

(5) Critics introduce reliable products, stores, and manufacturers.

For instance, some of many subject nodes in the trust network graph without trust values of FIG. 1 serve as the destination of inter-subject node relations (arrows) drawn from many subject nodes. A subject node serving as the destination of many inter-subject node relations (arrows) can be judged as a node that is trusted from many subjects in consumption activities. Also, a subject node serving as the destination of an inter-subject node relation (arrow) drawn from a trusted subject node can be judged as a highly reliable node.

Customers in general are expected to act relying on such trusted subject nodes such as experts, magazines, or other advertisement media. In other words, with the use of the trust relation information, consumption activities of customers can be predicted and this prediction can provide keys to sales operations.

The trust value calculation method of the present invention calculates trust values indicating which one of nodes in a trust network graph is more trustworthy than other nodes in order to detect such a highly reliable subject node. In the trust value calculation, a calculated value is weighted in accordance with the type of trust relation, and is weighted heavily in the case of a node that is known in advance as reliable and is weighted lightly in the case of a node that is known in advance as unreliable.

A trust network graph with trust values is constructed by assigning trust values that are calculated through the trust value calculation method of the present invention to subject nodes.

Trust Value Calculation System 1

FIG. 2 is a diagram showing an example of a configuration of the trust value calculation system 1 to which the trust value calculation method of the present invention is applied.

As shown in FIG. 2, the trust value calculation system 1 is used by users (subjects) and its components are connected to one another via a network 100 such as the Internet, a LAN, or a WAN. The components of the trust value calculation system 1 include a Web server 102 which publishes Web page data, a questionnaire device 104 which conducts a questionnaire survey on users to keep and publish answers from the users, a BBS server 108 which provides an electronic bulletin board function and publishes information posted to a bulletin board, client computers 106-1 to 106-n (n is an integer equal to or larger than 1, and does not always represent the same number), and a trust value calculation device 2.

It should be noted that, in the following description, an abbreviated term “client computer 106” may simply be used when there is no need to discriminate one of the identical components, which may be multiple, such as the client computers 106-1 to 106-n from another.

The following description may also use a collective term “processing node” for the client computers 106 and other devices that are capable of communication and information processing.

Subjects in the present invention are natural persons, legal entities, and things in general that are related to processing nodes, such as users of processing nodes, companies that use processing nodes and their products, and users who publish information on processing nodes such as the BBS server 108.

In the following description, substantially identical components and processing steps are denoted by the same reference symbols.

Also, the specification herein may avoid repetitive descriptions on components and processing steps that are denoted by the same reference symbols and shown in multiple drawings.

With these components, the trust value calculation system 1 creates information that indicates the trustworthiness of subjects based on information published by the Web server 102 and the questionnaire device 104.

Hardware Configuration

FIG. 3 is a diagram showing an example of a hardware configuration of the Web server 102, the questionnaire device 104, the client computers 106, the BBS server 108, and the trust value calculation device 2 which are shown in FIG. 2.

As shown in FIG. 3, each processing node of the trust value calculation system 1 includes a main body 120 which contains a CPU 122, a memory 124 and the like, an input/output device 126 which contains a keyboard, a display and the like, a communication device 128 which communicates with other processing nodes via the network 100, and storage 130 which records and reproduces data in a recording medium 132 such as an FD, a CD, a DVD, or an HD.

In other words, each processing node of the trust value calculation system 1 contains the components of a common computer that can communicate with other processing nodes via the network 100 (the same applies to each processing node throughout this specification).

Software Configuration

FIG. 4 is a diagram showing a configuration of a first trust network graph creation program 20, which is executed in the trust value calculation system 1 of FIG. 2.

As shown in FIG. 4, the first trust network graph creation program 20 includes a communication control module 200, a trustworthiness data creation module 202 (trustworthiness information collection means), a subject node extraction module 210, an inter-subject node relation extraction module 212, a sans-trust value network graph creation module 214, a weighting module 216, a trust value calculation module 220 (digitalization means), and a trust value-included network graph creation module 222.

The first trust network graph creation program 20 is supplied to the trust value calculation device 2 via the network 100 (FIG. 2) or via the recording medium 132 (FIG. 3), loaded onto the memory 124, installed in the trust value calculation device 2, and then executed with the use of specific hardware resources of the trust value calculation device 2 (the same applies to each program throughout this specification).

The communication control module 200 performs control for communication with other processing nodes.

The trustworthiness data creation module 202 creates data on trustworthiness which is used to extract users (subjects) of each processing node and an inter-subject node relation (arrow) defined between the subjects of each processing node from data published by the Web server 102, the questionnaire device 104, and the BBS server 108.

It should be noted that an inter-subject node relation that represents one user's (subject's) trust in another user (subject), for example, is directed from the former subject to the latter subject. In other words, the inter-subject node relation has directivity.

Processing executed by the trustworthiness data creation module 202 is described further.

FIG. 5 is a diagram showing an example of a post which is made by the user of one client computer 106 on a BBS run by the BBS server 108 of FIG. 1. The BBS server 108 may publish messages in a tree format so that an original comment (comment 1) posted under one thread and response comments (comments 1-1 and 1-2) posted in response to the original comment are associated with each other and, further, so that the response comment (comment 1-2) and a further response comment (comment 1-2-1) posted in response to the comment 1-2 are associated with each other.

Each of these comments may contain information indicating the contributor (contributor 1, 1-1, 1-2, 1-2-1), the time when the comment is made (contributing time 1, 1-1, 1-2, 1-2-1), and words (of appreciation, trust, and the like) expressing how much the contributor trusts in the contributor of a relevant comment. Some BBSs may include a numerical value indicating a contributor's evaluation of a relevant comment by another contributor.

Similarly, it is common that users of the client computers 106 make evaluations about various subjects in various forms such as natural language information and numerical value information in a Web page published by the Web server 102. In the same manner, questionnaire results published by the questionnaire device 104 are similar and include evaluations made by the users of the client computers 106 about various subjects in various forms such as natural language information and numerical value information.

The trustworthiness data creation module 202 thus collects the information published by the Web server 102, the questionnaire device 104, and the BBS server 108 from the Web server 102, the questionnaire device 104, and the BBS server 108. From the collected information, the trustworthiness data creation module 202 creates trustworthiness data containing subject nodes and inter-subject node relations through, for example, natural language processing.

The created trustworthiness data is output to the subject node extraction module 210, the inter-subject node relation extraction module 212, and the weighting module 216.

The subject node extraction module 210 (FIG. 4) extracts subject nodes (FIG. 1) from the trustworthiness data and outputs the extracted subject nodes to the inter-subject node relation extraction module 212 and the sans-trust value network graph creation module 214.

As described above, “subjects” relevant to a trust network of consumption activities include customers, experts (critics), advertisement media, magazines, Web sites, products, manufacturers, and stores. The subject node extraction module 210 extracts these subjects from the trustworthiness data as “subject nodes”.

The inter-subject node relation extraction module 212 creates from the trustworthiness data an inter-subject node relation (arrow) defined between subject nodes, and outputs the created inter-subject node relation (arrow) to the sans-trust value network graph creation module 214. In other words, the inter-subject node relation extraction module 212 links “subject nodes” corresponding to these “subjects” of consumption activities to each other with an inter-subject node relation (arrow) when the trustworthiness data contains information about some kind of trust relation between the subjects of consumption activities, and directs the arrow from one of the nodes that trusts in the other node toward the trusted other node.

Examples of a trust relation existing between subject nodes include “reviewed a product”, “wrote an article in a magazine”, “placed an advertisement”, “bought a product”, “manufactured a product”, “introduced a product”, and “hired an expert”.

Now, a description is given on an inter-subject node relation (arrow) linking subject nodes to each other.

An inter-subject node relation (arrow) is not created when there is no information on trustworthiness between nodes. In addition, two subject nodes are not always linked by a single inter-subject node relation (arrow), but may be linked by multiple inter-subject node relations (arrows).

For example, assuming the relationship between a critic A and a product B, in the case where the critic A writes about the function and price of the product B in a magazine C and, around the same time, the critic A writes about the performance of the product B in the magazine C, there are two inter-subject node relations (arrows) between a subject node that represents the critic A and a subject node that represents the product B.

Such information between subject nodes is taken into account in determining an inter-subject node relation (arrow). In this case, an inter-subject node relation (arrow) between a subject node uᵢ and a subject node uⱼ is expressed as AWinit(uᵢ→uⱼ)k (k=1˜m).

The sans-trust value network graph creation module 214 links subject nodes input from the subject node extraction module 210 with an inter-subject node relation (arrow) input from the inter-subject node relation extraction module 212 to create a trust network graph without trust values (FIG. 1), and outputs the created graph to the weighting module 216 and the trust value-included network graph creation module 222.

The weighting module 216 weights subject nodes and inter-subject node relations (arrows) that are contained in the trust network graph without trust values (FIG. 1) based on the trustworthiness data input from the trustworthiness data creation module 202, or data that is collected directly from information sources relevant to consumption activities (Web server 102 and the like). The result of the weighting processing is output to the trust value calculation module 220.

Data that the weighting module 216 collects directly from the Web server 102 is, for example, data obtained when the weighting module 216 accesses a page of a product which is used for the weighting processing through a URL [http://www.about.com] on the Web server 102 and refers to relevant Web pages. The weighting module 216 can also use a product introduction and product review in a magazine, an advertisement, questionnaire results, and the like as data for the weighting.

Data for the weighting may be obtained manually, or through information extraction processing which is an application of natural language processing. Data for the weighting may also be obtained through semi-automatic extraction processing which is a combination of the two.

When there is information about some kind of trust relation between subject nodes, the weighting module 216 weights the inter-subject node relation (arrow) based on the information. In the case where a reliable subject node is identified in advance from the collected information, the weighting module 216 weights this subject node with a higher weight value. The trust value calculation module 220 uses the result of the weighting processing input from the weighting module 216 to calculate the trust value of each subject node.

It should be noted that a subject node having a large trust value is deemed as a subject node of high reliability, and the larger the trust value, the higher the reliability.

Outline of Trust Value Calculation Processing by the Trust Value Calculation Module 220

The trust value calculation processing executed by the trust value calculation module 220 roughly includes the following steps. The trust value calculation module 220:

(1) selects one or more inter-subject node relations (arrows) between each pair of linked subject nodes;

(2) determines an initial weight value for every inter-subject node relation (arrow);

(3) calculates the sum of initial values of all the inter-subject node relations (arrows) pointing from the subject node uᵢ to the subject node uⱼ;

(4) calculates the sum of initial weight values of the inter-subject node relations (arrows) that originate from the node uᵢ;

(5) calculates an adjusted arrow weight Pᵢⱼ=AW_{adj}(uᵢ→uⱼ);

(6) defines a vector v;

(7) calculates a matrix E=e·v^{T} to calculate P′=cP+(1−c)E; and

(8) calculates a trust value TV(uᵢ) of the node uᵢ.

Details of the Trust Value Calculation Processing by the Trust Value Calculation Module 220

A more detailed description is given below of how the trust value calculation module 220 calculates the trust value of each subject node.

FIG. 6 is a flow chart showing the first trust value calculation processing of each subject node (S12) which is executed by the trust value calculation module 220 of FIG. 4. As shown in FIG. 6, the trust value calculation module 220 judges in Step 120 (S120) whether or not an arrow weighting calculation has been finished for all the subject nodes.

When the arrow weighting calculation has been finished for all the subject nodes, the trust value calculation module 220 proceeds to S136, otherwise the trust value calculation module 220 proceeds to S122.

In Step 122 (S122), the trust value calculation module 220 chooses one of the subject nodes that have not been processed in the previous rounds of trust value calculation processing (subject node uᵢ, for example) as a node to be processed in the next round of trust value calculation processing.

In Step 124 (S124), the trust value calculation module 220 judges whether or not all of the inter-subject node relations that are connected to the subject node uᵢ have been processed by the arrow weighting calculation processing. The trust value calculation module 220 returns to S120 when all of the inter-subject node relations connected to the subject node uᵢ have been processed by the arrow weighting calculation processing, otherwise the trust value calculation module 220 proceeds to S126.

In Step 126 (S126), the trust value calculation module 220 chooses any of the inter-subject node relations (arrows) that have not been processed in the previous rounds of the arrow weighting calculation processing for the subject node uᵢ (for example, inter-subject node relation (arrow) between the subject node uᵢ and the subject node uⱼ) as an arrow to be processed in the next round of the arrow weighting calculation processing.

In Step 128 (S128), the trust value calculation module 220 determines initial weight values for all of the inter-subject node relations (arrows) between the subject nodes uᵢ and uⱼ. The trust value calculation module 220 further determines the initial weight value of the inter-subject node relation (arrow) AWinit(uᵢ→uⱼ)k (k=1˜m) in accordance with information about the relation between the subject nodes uᵢ and uⱼ.

In Step 130 (S130), the trust value calculation module 220 calculates a sum (1), which is the sum of the initial values of the inter-subject node relations (arrows) pointing from the subject node uᵢ to the subject node uⱼ. A sum AWacc (uᵢ→uⱼ) of the initial values of the inter-subject node relations (arrows) is obtained by the following formula:

$${AW}_{acc} ( {u}_{i} -> {u}_{j} ) = {\sum }_{k = 1}^{m} {AW}_{init} ( {u}_{i} -> {u}_{j} ) k \qquad Expression 1$$

In Step 132 (S132), the trust value calculation module 220 calculates a sum (2) AW_{acc}(uᵢ), which is the sum of the initial weight values of the inter-subject node relations (arrows) that originate from the subject node uᵢ.

In Step 134 (S134), the trust value calculation module 220 calculates an adjusted weight Pᵢⱼ by the following Expression 2, and then returns to S124.

Pᵢⱼ=AW_{acc}(uᵢ→uⱼ)/AW_{acc}(uᵢ) Expression 2

This adjustment enables the weight value of each inter-subject node relation (arrow) between subject nodes by Pᵢⱼ to be expressed in the range from 0 to 1.

In Step 136 (S136), the trust value calculation module 220 defines a vector v.

It should be noted that elements of the vector v each represent a weight of each subject node. The sum of the elements is 1.

The value of the vector v is regarded as the extent of trust in a subject node, and is determined based on, for example, a review of the subject node in a magazine, personal feelings about the trustworthiness of the subject node, and rating information provided by a rating agency or the like.

The value of the vector v may be adjusted to suit a certain purpose of a consumer, thereby obtaining a trust value that takes the consumer's purpose into account.

In Step 140 (S140), the trust value calculation module 220 obtains the matrix E=e·v^{T} to calculate P′=cP+(1−c)E.

The trust value calculation module 220 uses a vector e whose elements are all 1 to obtain the matrix E=e·v^{T} and then calculates P′=cP+(1−c)E, where c is a constant that satisfies 0≦c≦1, and the optimum value of c can be obtained from experiments.

In Step 142 (S142), the trust value calculation module 220 calculates the trust value TV(uᵢ) of the subject node uᵢ by the following Expression 3, and ends the processing.

$$T V ( {u}_{i} ) = {\sum }_{{u}_{j} ∈ BN ( {u}_{i} )} {P}^{′} ( {u}_{j} -> {u}_{i} ) T V ( {u}_{j} ) \qquad Expression 3$$

Here, Expression 4 expresses a set of nodes that have inter-subject node relations (arrows) pointing toward the node uᵢ.

uⱼεBN(uᵢ) Expression 4

When a vector X^{T} is defined as X^{T}=(TV(u₁), . . . , TV(uₙ)), Expression 3 can be expressed by the following Expression 5. Accordingly, when the trust value calculation module 220 obtains the vector X as an eigen vector of an eigen value 1 of a transposed matrix of the matrix P′, values of the eigen vector X each equal the trust values of each of the subject nodes.

Of those, the node uⱼ whose value of TV(uⱼ) is large is deemed as a node (subject) of high reliability.

\vec{X}=P′^{T}\vec{X} Expression 5

These calculation results can be applied to the following consumption activities:

(a) If the calculation results show that one manufacturer is trusted more than others, a product of this more trusted manufacturer is introduced and recommended.

(b) Consumers can purchase a product of the most trusted manufacturer at the most trusted store.

However, because products are not subjects in which trust is placed, a trust relation with a product is redrawn as an indirect trust relation through a product. For example, in the case where an expert recommends a certain product, it is considered that the expert trusts the manufacturer of the product.

The trust value-included network graph creation module 222 maps trust values calculated by the trust value calculation module 220 in the above-mentioned manner onto subject nodes of the trust network graph without trust values (FIG. 1) which has been input from the sans-trust value network graph creation module 214. The trust value-included network graph creation module 222 thus creates a trust network graph with trust values exemplified in FIGS. 8 to 10, and outputs the created graph to the input/output device 126 (FIG. 3) of the trust value calculation device 2 and the like.

Overall Operation of the Trust Value Calculation System 1

FIG. 7 is a flow chart showing an overall operation (S10) of the trust value calculation system 1 of FIG. 2.

As shown in FIG. 7, in Step 100 (S100), information obtained from the users of the client computers 106 is written into the trust value calculation device 2 (FIG. 2, FIG. 4), which also collects published data from the Web server 102, the questionnaire device 104, and the BBS server 108, such as Web page data of a Web site, questionnaire answers, and comments posted on a BBS.

In Step 102 (S102), the trust value calculation device 2 creates trustworthiness data from the information collected from the Web server 102 and the like.

In Step 104 (S104), the trust value calculation device 2 extracts subject nodes from the trustworthiness data.

In Step S106 (S106), the trust value calculation device 2 extracts inter-subject node relations (arrows) from the trustworthiness data.

In Step S108 (S108), the trust value calculation device 2 creates a trust network graph without trust values (FIG. 1) from the extracted subject nodes and inter-subject node relations (arrows).

In Step 12 (S12), the trust value calculation device 2 calculates trust values of the subject nodes in the manner described above with reference to FIG. 6.

In Step 110 (S110), the trust value calculation device 2 maps the trust values of the subject nodes obtained in S12 onto the trust network graph without trust values obtained in S108 to create a trust network graph with trust values, and outputs the created graph to the input/output device 126 (FIG. 3) and the like.

Specific Example of a Trust Network

Described below is an example in which specific values are mapped onto a trust network graph as subject nodes trust values calculated by the trust value calculation system 1 as described above.

FIGS. 8 to 10 are diagrams showing examples of a trust network graph onto which specific values are mapped as subject node trust values calculated by the trust value calculation system 1. It should be noted that, in FIGS. 8 to 10, numbered boxes represent subject nodes, and an italic numerical value outside each subject node indicates the calculated trust value of the subject node.

Trust values are calculated under the conditions that c=0.85 and every value of the vector v is “1/n”. A bracketed numerical value indicates a weight value of an inter-subject node relation (arrow).

In the example of FIG. 8, the weight value of each inter-subject node relation (arrow) is 1.0.

In FIG. 9, conditions for calculating the trust values of subject nodes are the same as in the example of FIG. 8, except that the weight value is set to 10.0 for specific inter-subject node relations (arrows: the arrow from the subject node 2 to the subject node 5, the arrow from the subject node 3 to the subject node 5, the arrow from the subject node 7 to the subject node 3, and the arrow from the subject node 7 to the subject node 8).

A comparison between FIG. 8 and FIG. 9 shows that how inter-subject node relations (arrows) are weighted changes the trust values of subject nodes. Specifically, the trust value of the subject node 1 is changed from 0.366 in FIG. 8 to 0.3016 in FIG. 9, and the trust value of the subject node 4 is changed from 0.378 in FIG. 8 to 0.287 in FIG. 9. In other words, whereas the trust value of the subject node 4 is larger than that of the subject node 1 in FIG. 8, the trust value of the subject node 1 is larger than that of the subject node 4 in FIG. 9.

FIG. 10 shows an example in which conditions for calculating the trust values of subject nodes are the same as in the example of FIG. 8, except that the weight value of a specific inter-subject node relation (arrow: the arrow from the subject node 5 to the subject node 6) is set to 3.0.

The trust value of the subject node 2 is changed from 0.0545 in FIG. 8 to 0.0665 in FIG. 10, and the trust value of the subject node 5 is changed from 0.055 in FIG. 8 to 0.0588 in FIG. 10, which makes the subject node 2 larger in the trust value than the subject node 5 in FIG. 10 whereas the subject node 5 has a larger trust value than the subject node 2 in FIG. 8.

A trust value that reflects an individual's preference profile can be obtained by changing the weight values of subject nodes and inter-subject node relations (arrows) based on the individual's preference profile information as shown in FIGS. 8 to 10. An example is given in which the tendency of an individual's preference is similar to contents of a fashion magazine A.

Elements of the vector v obtained in S136 of FIG. 6 each represent a weight of a subject node, and the sum of the elements is 1.

Changing the value of the vector v to suit a certain purpose yields a trust value that reflects the purpose. If the vector v is set to a large value for a subject node corresponding to the fashion magazine A, the resultant trust values of each subject node reflect the tendency of the fashion magazine A.

Another possible application example of the trust value calculation system 1 is individualization by making the trust value calculation reflect the extent of a trust relation between subjects which is known in advance or on which emphasis is to be placed. Shown below is an example in which this individualization is achieved by changing the weight values of inter-subject node relations (arrows).

As described above, one or more inter-subject node relations (arrows) are drawn between subject nodes that have some relations with each other. For instance, if subjects relevant to a specific magazine and inter-subject node relations (arrows) between these subjects and other subjects that have trust relations with the subjects are weighted heavily in the trust value calculation, the resultant trust values include trust values specific to subscribers of the magazine.

As a result, a product of a subject that is deemed as trusted is recommended or introduced, and a product suited better to the subscribers of the magazine is recommended or introduced to the subscribers. Individualization like this is achieved by changing the weights of inter-subject node relations (arrows) or changing the adjusted weight Pᵢⱼ, so a trust relation specific to an individual or a group to which an individual belongs is used in the trust value calculation.

Further, changing the vector v obtained in S136 of FIG. 6 and the weight values of the inter-subject node relations (arrows) makes the trust value calculation reflect an individual's preference profile information, which contains a diversity of information such as age, gender, yearly income, family structure, hobby, and likes and dislikes.

As described above, the trust value calculation system 1 can provide an index indicating which manufacturer, store, expert, etc. are likely to be trustworthy by calculating trust values in consumption activities. Further, there are many conceivable applications of the calculated trust values, including a case where the trust values are consulted by customers in selecting stores and manufacturers, and by stores and manufactures in selecting media in which advertisements are to be placed.

Also, while FIG. 2 shows an example in which the trust value calculation system 1 calculates trust values that reflect information published by the Web server 102, the questionnaire device 104, and the BBS server 108, the trust value calculation system 1 may be modified such that the trust value calculation reflects not only from information on the Internet but also information about trust from various data sources such as advertisements, questionnaires, and magazine articles.

The trust value calculation system 1 may also be modified such that the trust value calculation reflects the type of the trust relation and information about a subject whose extent of trustworthiness is known in advance.

Second Trust Network Graph Creation Program 24

The following is a description on a modification example of the above-mentioned trust network graph creation program 20.

FIG. 11 is a diagram showing the configuration of a second trust network graph creation program 24 which runs on the trust value calculation device 2 shown in FIG. 2. As shown in FIG. 11, the trust network graph creation program 24 has a trust value calculation module 246, which is a replacement of the trust value calculation module 220 in the trust network graph creation program 20 of FIG. 4 and executes processing different from that of the trust value calculation module 220, and additional components: a time management module 240, a database (DB) 242, and a time-based weighting module 244.

The second trust network graph creation program 24 is used by the trust value calculation device 2 in place of the first trust network graph creation module 20, and is improved to be capable of making changes in trust values over time reflected on the creation of a trust network graph.

The time management module 240 activates the rest of the components of the trust network graph creation program 24 at regular intervals, for example, so a trust network graph with trust values is created periodically.

The DB 242 stores, in order, periodically created trust network graphs with trust values and data (subjects and inter-subject node relations (arrows)) used to create the trust network graphs with the trust values in association with the time of the creation.

The time-based weighting module 244 reads previously created inter-subject node relations (arrows) and the time of the creation out of the DB 242 and controls the trust value calculation module 246 such that a newer inter-subject node relation (arrow) is weighted progressively more heavily and an older inter-subject node relation (arrow) is weighted progressively more lightly in the trust value calculation.

Under control of the time-based weighting module 244, the trust value calculation module 246 calculates trust values and outputs the calculated values to the trust value-included network graph creation module 222. The processing executed by the trust value calculation module 246 is described below with reference to FIG. 12 taking as an example a case where an inter-subject node relation (arrow) is weighted differently at two time points T0 and T1.

FIG. 12 is a flow chart showing second subject node trust value calculation processing (S16) which is executed by the trust value calculation module 246 of FIG. 11. In other words, the processing performed by the trust value calculation module 246 of FIG. 11 is a modification of the processing (S12), which is shown in FIG. 6 and executed by the trust value calculation module 220, and replaces S128 to S132 of S12 with S160 to S166 of S16.

In Step 160 (S160), the trust value calculation module 246 determines an initial weight value (for example, 0.1) for all of inter-subject node relations (arrows) between the subject nodes uᵢ and uⱼ at the earlier time (T0). The trust value calculation module 246 further determines the initial weight value of the inter-subject node relation (arrow) AWinit(uᵢ→uⱼ)k (k=1˜m) in accordance with contents of information about a relation between the subject nodes uᵢ and uⱼ at the earlier time (T0).

In Step 162 (S162), the trust value calculation module 246 determines an initial weight value (for example, 1.0) for all of inter-subject node relations (arrows) between the subject nodes uᵢ and uⱼ at the current time (T1). The trust value calculation module 246 further determines the initial weight value of the inter-subject node relation (arrow) AWinit(uᵢ→uⱼ)k (k=1˜m) in accordance with contents of information about a relation between the subject nodes uᵢ and uⱼ at the current time (T1).

In Step 164 (S164), the trust value calculation module 246 calculates a sum (1) as the sum of initial values of all inter-subject node relations (arrows) pointing from the subject node uᵢ to the subject node uⱼ at the earlier time (T0) and the current time (T1). The sum AW_{acc}(uᵢ→uⱼ) of the initial values of the inter-subject node relations (arrows) is obtained by Expression 1 as described above.

In Step 166 (S166), the trust value calculation module 246 calculates the sum (2) AW_{acc}(uᵢ) as the sum of initial weight values of inter-subject node relations (arrows) that originate from the subject node uᵢ at the earlier time (T0) and the current time (T1).

FIG. 13 is a diagram showing an example of subjects and inter-subject node relations (arrows) in a community constituted of three members (subject nodes A, B, and C). In FIG. 13, (A) shows subjects and inter-subject node relations (arrows) at a time T0 whereas (B) shows subjects and inter-subject node relations (arrows) at a time T1, which is later than the time T0.

For example, in the case where the subjects and the inter-subject node relations (arrows) shown in (A) of FIG. 13 (the inter-subject node relation arrow from the subject node C to the subject node B and the inter-subject node relation arrow from the subject node B to the subject node A) are observed in this community at (or prior to) the time T0, trust values calculated for the subject nodes A, B, and C by the trust value calculation module 220 of the trust network graph creation program 20 in the manner shown in FIG. 6 are 0.4744, 0.3412, and 0.1844, respectively.

If, for example, an inter-subject node relation (arrow) from the subject node B to the subject node C is generated in a period between the time T0 and the time T1, trust values calculated for the subject nodes A, B, and C by the trust value calculation module 220 of the trust network graph creation program 20 in the manner shown in FIG. 6 are 0.3032, 0.3936, and 0.3032, respectively.

In contrast, If, for example, an inter-subject node relation (arrow) from the subject node B to the subject node C is generated in a period between the time T0 and the time T1 as shown in (B) of FIG. 13, trust values calculated for the subject nodes A, B, and C by the trust value calculation module 246 of the trust network graph creation program 24 shown in FIG. 11 with a weight for the relations at the time T0 set to 0.1 and a weight for the relations at the time T1 set to 1.0 are 0.1183, 0.4502, and 0.4314, respectively.

During the period between the time T0 and the time T1, the subject node A has gained no new trust relation, and the subject node C which has gained a trust from the subject node B is easily expected to be more trustworthy than the subject node A. Still, the above proves that the trust value calculation module 246 of the trust network graph creation program 24, which changes the weight of inter-subject node relations (arrows) in accordance with the passage of time, is capable of a trust value calculation that reflects the trust relations at the recent time T1 more.

Access Control System 3

A description will be given below of a first access control system 3 according to the present invention which is an application of the trust value calculation system 1 described with reference to FIG. 1 to FIG. 13 and performs access control of processing nodes.

FIG. 14 is a diagram showing an example of the configuration of the first access control system 3 according to the present invention. As shown in FIG. 14, the first access control system 3 includes processing nodes connected via the network 100 in a manner that allows the processing nodes to communicate with one another. The processing nodes include an SNS server 300, the BBS server 108, an access control device 4, and the client computers 106.

It should be noted that the access control system 3 may further include the Web server 102, the questionnaire device 104, and the like as the trust value calculation system 1 does.

With these components, the first access control system 3 makes a proposal to a subject that holds data or the like to be accessed in a processing node (first subject) about access control in which access to the data holding processing node by a second subject (subject that accesses data stored in the processing node) is controlled in accordance with a change in trust value ranking of the second subject.

It should be noted that a second subject (subject that accesses a data holding processing node) can be a first subject (subject that keeps data to be accessed), and, vice versa, (first subject (a subject that keeps data to be accessed) can be a second subject (subject that accesses a data holding processing node)).

Any type of subjects can have any arbitrary processing node store data to be accessed in an arbitrary processing node.

Any type of subjects can have any arbitrary processing node access arbitrary data stored in an arbitrary processing node as long as it is not prohibited by access control.

If the following description is mentioned as if one type of subject were associated with a specific processing node, it is only for making the description clear and concrete.

Access Control Method

For example, functions of the SNS server 300 include:

(1) keeping information that is uploaded by an SNS member himself/herself, such as a journal, and determining a publication range of the kept information; and

(2) denying access to the information of himself/herself from other specific SNS members.

These functions are enabled manually by a member or automatically by the server.

Functions of the Web server 102 include:

(1) controlling access from specific users to a Web page that is created and kept in the Web server 102 by a user of one client computer 106;

(2) allowing only specific users to access a Web page that is created by a user of one client computer 106; and

(3) protecting access to a Web page that is created by a user of one client computer 106 with a password or by encryption.

These functions are enabled manually by a user or automatically by the server.

Similar to the Web server 102, functions of the BBS server 108 include:

(1) controlling access from specific users to BBS data written and kept in the BBS server by a user;

(2) allowing only specific users to access a BBS; and

(3) protecting access to a BBS with a password or by encryption.

These functions are enabled manually by a user or automatically by the server.

FIG. 15 is a diagram showing the configuration of a client program 14, which is run on each client computer 106 shown in FIG. 14. As shown in FIG. 15, the client program 14 includes a user interface module (UI) 140, which inputs and outputs data to and from a user via the input/output device 126 (FIG. 3), a browser 142, which is used to view Web pages and the like, a firewall 144, and a protection level setting module 146.

The protection level setting module 146 sets settings of the firewall 144 and settings for access control of the BBS server 108 and the SNS server 300 which a user of one client computer 106 is using. These settings are set in response to an operation made in accordance with a protection level changing proposal displayed on the input/output device 126.

The firewall 144 is set manually by the user or automatically to:

(1) accept access to the client computers 106 only from specific users;

(2) forbid access to the client computers 106 only from specific users;

(3) forbid the browser 142 to access a specific processing node;

(4) control information transmission from the client computer 106 to the outside in accordance with the protection level when the browser 142 is connected to the network 100.

Software

FIG. 16 is a diagram showing a first access control program 26, which is run on the access control system 3 shown in FIG. 14. As shown in FIG. 16, the access control program 26 includes the components of the trust network graph creation program 20 of FIG. 4 and additional components: a time management module 240, a ranking module 260 (ranking means), a DB 262, a ranking change detection module 264 (change detecting means), and a protection level change proposing module 266 (access control proposal information creating means: control proposal information creating means).

With these components, the access control program 26 ranks subject nodes in accordance with their trust values, detects changes in trust value ranking, and makes an access control proposal to subjects in a manner that the access control program 26 tightens access control over a subject whose rank has worsened significantly while easing access control over a subject whose rank has improved significantly, or has the respective devices in the access control system 3 automatically execute such access control.

The ranking module 260 periodically, for example, ranks each subject in a trust network graph with trust values which is created by the trust value-included network graph creation module 222 in accordance with the subjects' trust values. And, a subject having a larger trust value is ranked higher and a subject having a smaller trust value is ranked lower. The ranking results are stored in the DB 262 with a time stamp.

The DB 262 stores the ranking results and its time stamp input from the ranking module 260, together with periodically created trust network graphs with trust values, data used in the creation thereof (e.g., inter-subject node relations), and the time of creation thereof.

The data stored in the DB 262 is used in processing that is executed by other components of the access control program 26 as the need arises.

The ranking change detection module 264 reads two ranks of each subject at a time T0 and a time T1 (T0 is earlier than T1) stored in the DB 262, for example, to calculate the difference between the ranks at the time T0 and the time T1.

The ranking change detection module 264 further calculates the deviation value of each subject's difference between the rank at the time T0 and the rank at the time T1, to thereby detect a subject whose trust value-based rank has changed significantly.

It should be noted that whether or not a subject's rank has changed significantly is judged from whether the deviation value of the respective subject's rank difference is extremely large or small.

For example, when s is given as the standard deviation of rank differences and when x is given as the rank difference of a member whose deviation value is to be obtained (mean rank difference is 0), the deviation value of the rank difference of this subject is calculated by (10x/s+50).

In the case where the distribution of rank differences is normal distribution, about 68.3% of the subjects fall between rank difference deviation values 40 and 60, about 95.4% of the subjects fall between rank difference deviation values 30 and 70, and about 99.73% of the subjects fall between rank difference deviation values 20 and 80.

Accordingly, when the deviation value of a subject is less than 30, for example, it is deduced that the trust value rank of the subject has worsened as sharply as would be experienced by only 2.3% of all the subjects ((100−95.4)/2=2.3(%)). The ranking change detection module 264 thus detects that there has been a significant change in trustworthiness of this subject.

To the contrary, When the deviation value of a subject is more than or equal to 70, for example, it is deduced that the trust value rank of the subject has improved as greatly as would be experienced by only 2.3% of all the subjects. The ranking change detection module 264 thus detects that there has been a significant change in trustworthiness of this subject.

The protection level change proposing module 266 makes an access control proposal to a subject that keeps data to be accessed in a manner that the protection level change proposing module 266 tightens access control more (by increasing the protection level) over a subject whose trustworthiness is found to have significantly dropped by the ranking change detection module 264, compared to access control settings previously set by the subject that keeps the data to be accessed. Alternatively, the protection level change proposing module 266 automatically changes access control settings of the data to be accessed in the manner described above.

To the contrary, the protection level change proposing module 266 makes an access control proposal to a subject that keeps data to be accessed in a manner that the protection level change proposing module 266 eases access control more (by decreasing the protection level) over a subject whose trustworthiness is found to have significantly improved by the ranking change detection module 264, compared to access control settings previously set by the subject that keeps the data to be accessed. Alternatively, the protection level change proposing module 266 automatically changes access control settings of the data to be accessed in the manner described above.

The protection level change proposing module 266 also makes an access control proposal to a subject that keeps data to be accessed in a manner that the protection level change proposing module 266 tightens access control more over a subject whose trustworthiness is found to have significantly dropped by the ranking change detection module 264, compared to access control settings set prior to the detection of the significant drop in trustworthiness. Alternatively, the protection level change proposing module 266 automatically changes access control settings of data to be accessed in the manner described above.

To the contrary, the protection level change proposing module 266 makes an opposite access control proposal to a subject that keeps data to be accessed to ease access control over a subject whose trustworthiness is found to have significantly improved by the ranking change detection module 264, compared to access control settings set prior to the detection of the significant improvement in trustworthiness. Alternatively, the protection level change proposing module 266 automatically changes access control settings of data to be accessed in the manner described above.

It should be noted that the protection level change proposing module 266 may make an access control proposal to a subject that keeps data to be accessed, or automatically change access control settings of data to be accessed, based simply on the trustworthiness rank of each accessing subject in place of a significant change in trustworthiness detected by the ranking change detection module 264.

The processing executed by the protection level change proposing module 266 will be described further below.

The description given here of the processing of the protection level change proposing module 266 employs as a specific example an SNS or other similar communities in which four different protection levels from strict to light, “No access”, “Read only”, “Read and Write”, “Read, Write, view members list”, can be set.

In this community, a community member (subject) A sets in advance one of the above-mentioned four protection levels against each of other members who access data that the community member A keeps. The protection level is set in data access control information located in the SNS server 300 or other processing nodes that run communities.

For example, when the community member (subject) A sets “Read only” to another community member B in advance and the rank of the community member B improves later, the protection level change proposing module 266 proposes that the community member A should ease the protection level against the community member B to “Read and Write” or lower.

To the contrary, when the community member (subject) A sets “Read only” to another community member B in advance and the rank of the community member B worsens later, the protection level change proposing module 266 proposes that the community member A should tighten the protection level against the community member B to “No access”.

Hereinafter, each time the trustworthiness rank of the community member B changes significantly, the protection level change proposing module 266 proposes increasing or decreasing the protection level set prior to the change against the community member B, depending on whether the change is improvement or a setback.

It should be noted that as described below, the protection level is changed in various ways suited to different subjects for which the protection level is changed, so the protection level change proposing module 266 chooses an appropriate subject to make an access control proposal to.

For example, to change the protection level for the SNS server 300, the protection level change proposing module 266 makes an access control proposal to a member of an SNS which includes, for example, (1) setting a publication range of the SNS member's own information such as a journal, and (2) forbidding access to own information to other specific SNS members. As a result, the member who has received the proposal manually accesses the SNS server 300, or the client program 14 automatically accesses the SNS server 300, to change the access control settings in accordance with the proposal.

For example, the protection level can also be changed by the direct proposal to the SNS server 300 from the protection level change proposing module 266. As a result, the SNS server 300 in this case automatically makes the above-mentioned changes to the access control settings.

To give an example of how the protection level is changed for the Web server 102, the protection level change proposing module 266 makes an access control proposal to a user (subject) of the Web server 102 which includes, for example, (1) limiting access from specific processing nodes to a Web page that is created by a user of one client computer 106, (2) allowing only specific processing nodes and their users to access a Web page that is created by a user of one client computer 106, and (3) protecting access to a Web page that is created by a user of one client computer 106 with a password or by encryption. As a result, the user who has received the proposal manually accesses the Web server 102, or the client program 14 automatically accesses the Web server 102, to change the access control settings in accordance with the proposal.

For example, the protection level can also be changed for the Web server 102 by the direct proposal to the Web server 102 from the protection level change proposing module 266. As a result, the Web server 102 in this case automatically makes the above-mentioned changes to the access control settings.

To give an example of how the protection level is changed for the BBS server 108, the protection level change proposing module 266 makes an access control proposal to a user (subject) of the BBS server 108 which includes, for example, (1) limiting access from specific processing nodes to a BBS, (2) allowing only specific processing nodes and their users to access a BBS, and (3) protecting access to a BBS with a password or by encryption. As a result, the user who has received the proposal manually accesses the BBS server 108, or the client program 14 automatically accesses the BBS server 108, to change the access control settings in accordance with the proposal.

For example, the protection level can also be changed for the BBS server 108 by the direct proposal to the BBS server 108 from the protection level change proposing module 266. As a result, the BBS server 108 in this case automatically makes the above-mentioned changes to the access control settings.

To give an example of how the protection level is changed for the firewall 144, the protection level change proposing module 266 makes an access control proposal to the client computer 106 which includes, for example, (1) accepting access to the client computer 106 only from specific processing nodes, (2) forbidding specific processing nodes to access the client computer 106, (3) forbidding the browser 142 to access a specific processing node, and (4) controlling what information is provided from the client computer 106 to the outside in accordance with the protection level when the browser 142 is connected to the network 100. As a result, the user who has seen the proposal on the client computer 106 changes the settings of the firewall 144 in accordance with the proposal.

For example, the protection level can also be changed for the firewall 144 by the proposal to the firewall 144 from the protection level change proposing module 266. As a result, the firewall 144 in this case automatically makes the above-mentioned changes to the firewall settings.

Overall Operation of the Access Control System 3

FIG. 17 is a flow chart showing the overall operation (S18) of the access control system 3 of FIG. 14.

As shown in FIG. 17, in Step 180 (S180), the access control device 4 ranks subjects in accordance with their trust values.

In Step 182 (S182), the access control device 4 judges whether or not the subjects newly ranked by their trust values include any subject whose rank is improved from the last time.

The access control device 4 proceeds to S184 when there exists a subject whose rank is improved from the last time, and otherwise moves to S186.

In Step 184 (S184), the access control device 4 suggests, to an appropriately selected processing node, decreasing the protection level against a processing node corresponding to the subject whose rank has improved.

In Step 186 (S186), the access control device 4 judges whether or not the subjects newly ranked by their trust values include any subject whose rank worsens from the last time.

The access control device 4 proceeds to S188 when there exists a subject whose rank worsens from the last time, and otherwise ends the processing.

In Step 188 (S188), the access control device 4 suggests, to an appropriately selected processing node, increasing the protection level against a processing node that corresponds to the subject whose rank has worsened.

Modification Example of the Access Control Program

FIG. 18 is a diagram showing the configuration of a second access control program 28, which is used by the access control device 4 of FIG. 14 in place of the first access control program 26 shown in FIG. 16.

FIG. 19 is a flow chart showing the overall operation (S20) of the access control system 3 when the access control program 28 of FIG. 18 is executed in the access control device 4 of FIG. 14.

As shown in FIG. 18, the second access control program 28 has the components of the second trust network graph creation program 24 and additional components: the time management module 240, the time-based weighting module 244, the trust value calculation module 246, the ranking module 260, the ranking change detection module 264, and the protection level change proposing module 266.

Executing the access control program 28 in the access control device 4 of the access control system 3 makes it possible to execute the processing (S16) of FIG. 12 which is performed by the trust value calculation module 246 in combination with the access control processing (S18) of FIG. 17, as shown in FIG. 19.

It should be noted that the above-mentioned access control system according to the present invention has the following technical advantages:

(1) Using a community access protection system to monitor security changes within a community lets community members concentrate on community activities.

(2) The community access protection system informs community members of security changes within a community and the timing when to change the protection settings, thereby releasing community members from the security monitoring, which is usually troublesome for community members.

(3) Community members can receive a proposal about what changes should be made to the security settings.

(4) Subjects can possibly be ranked more appropriately if the characteristics of trust network graphs are used (subject nodes and arrows can have types and attributes, and the weight can be varied).

(5) Ranking that gives importance to the current trust situation can be achieved by writing a time when a trust relation arrow has been created as an attribute of the arrow and by weighting a more recent arrow progressively more heavily in the trust value calculation.

(6) Recording, as an attribute of a trust relation arrow, to what field a message around which the trust relation has been formed belongs makes it possible to extract a trust relation relevant to the field to which a member has strong ties.

If this attribute is used in creating a subgraph of the original trust network graph, detection of such a person can be possible whose message with regard to one field is not reliable but whose message with regard to another field is reliable.

### INDUSTRIAL APPLICABILITY

The present invention can be applicable to access control in a network.

### DESCRIPTION OF REFERENCE NUMERALS

1 . . . trust value calculation system
100 . . . network
102 . . . Web server
120 . . . main body
122 . . . CPU
124 . . . memory
126 . . . input/output device
128 . . . communication device
130 . . . storage
132 . . . recording medium
104 . . . questionnaire device
106 . . . client computer
14 . . . client program
140 . . . user interface module (UI)
142 . . . browser
144 . . . firewall
146 . . . protection level setting module
108 . . . BBS server
300 . . . SNS server
2 . . . trust value calculation device
20, 24 . . . trust network graph creation program
200 . . . communication control module
202 . . . trustworthiness data creation module
210 . . . subject node extraction module
212 . . . inter-subject node relation extraction module
214 . . . sans-trust value network graph creation module
216 . . . weighting module
220 . . . trust value calculation module
222 . . . trust value-included network graph creation module
240 . . . time management module
242, 262 . . . DB
244 . . . time-based weighting module
246 . . . trust value calculation module
4 . . . access control device
26, 28 . . . access control program
260 . . . ranking module
264 . . . ranking change detection module
266 . . . protection level change proposing module

What is claimed is:

1. An access control device for separately controlling access of one or more second subjects to data that is kept in one or more of multiple processing nodes by each of one or more first subjects, the second subjects being subjects excluding the first subjects, the processing nodes holding data of the first subjects each controlling access of the respective second subjects to the data of the first subjects based on access control information, comprising:
trustworthiness information collecting means for collecting trustworthiness information, which indicates trustworthiness of each of the second subjects, from one or more of the multiple processing nodes; and
access control proposal information creating means for creating the access control proposal information, which is used to separately control access of the second subjects to each piece of the data of the first subjects, based on access control information that each of the first subjects sets to its own data in advance, and based on the collected trustworthiness information.

2. An access control device according to claim 1, wherein the access control proposal information creating means includes:
digitalization means for digitalizing the collected trustworthiness information; and
control proposal information creating means for creating the access control proposal information based on the access control information that each of the first subjects sets to its own data in advance, and based on the digitalized trustworthiness information.

3. An access control device according to claim 2, wherein:
the trustworthiness information collecting means collects the trustworthiness information over time; and
the digitalization means digitalizes the trustworthiness information such that the trustworthiness information collected at one time has larger influence on the created access control proposal information than the trustworthiness information collected at an earlier time point does.

4. An access control device according to claim 2, wherein:
the access control proposal information creating means further includes ranking means for ranking the trustworthiness of each of the second subjects based on the created trustworthiness information; and
the access control proposal information creating means uses trustworthiness rank of each of the second subjects as the digitalized trustworthiness information to create the access control proposal information.

5. An access control device according to claim 4, wherein:
the access control proposal information creating means further includes change detecting means for detecting changes in trustworthiness rank of each of the second subjects over time; and
the access control proposal information creating means creates the access control proposal information such that access control over the second subject whose trustworthiness is detected to have improved is eased compared to before the detection, and access control over the second subject whose trustworthiness is detected to have worsened is tightened compared to before the detection.

6. An access control device according to claim 5, wherein the change detecting means calculates, for each of the second subjects, a deviation value of a change between trustworthiness ranks assigned at least at two points in time, detects an improvement in trustworthiness of the second subject when the deviation value of the change between trustworthiness ranks falls within a given first range, and detects a drop in trustworthiness of the second subject when the deviation value of the change in trustworthiness rank falls within a given second range.

7. An access control device according to claim 1, wherein the access control proposal information comprises protection level information, which is used to protect the data of the first subjects by controlling access by the respective second subjects to the data of the first subjects.

8. An access control device according to claim 1, wherein the trustworthiness information collection means collects as the trustworthiness information an evaluation of each piece of information on the second subjects which is published in the multiple processing nodes.

9. An access control method for separately controlling access of one or more second subjects to data that is kept in one or more of multiple processing nodes by each of one or more first subjects, the second subjects being subjects excluding the first subjects, the processing nodes holding data of the first subjects each controlling access of the respective second subjects to the data of the first subjects based on access control information, comprising:
a trustworthiness information collecting step of collecting trustworthiness information, which indicates trustworthiness of each of the second subjects, from one or more of the multiple processing nodes; and
an access control proposal information creating step of creating the access control proposal information, which is used to separately control access of the second subjects to each piece of the data of the first subjects, based on access control information that each of the first subjects sets to its own data in advance, and based on the collected trustworthiness information.

10. An access control method according to claim 9, wherein the access control proposal information creating step includes:
a digitalization step of digitalizing the collected trustworthiness information; and
a control proposal information creating step of creating the access control proposal information based on the digitalized trustworthiness information.

11. An access control program for separately controlling access of one or more second subjects to data that is kept in one or more of multiple processing nodes by each of one or more first subjects, the second subjects being subjects excluding the first subjects, the processing nodes holding data of the first subjects each controlling access of the respective second subjects to the data of the first subjects based on access control information, the access control program causing a computer to execute:
a trustworthiness information collecting step of collecting trustworthiness information, which indicates trustworthiness of each of the second subjects, from one or more of the multiple processing nodes; and
an access control proposal information creating step of creating the access control proposal information, which is used to separately control access of the second subjects to each piece of the data of the first subjects, based on access control information that each of the first subjects sets to its own data in advance, and based on the collected trustworthiness information.
